(19) United States
(12) Patent Application Publication
(10) Pub. No.: US 2013/0019768 A1
(43) Pub. Date: Jan. 24, 2013

(54) Relief Printing Apparatus, Printed Matter Using the Same, and Method of Manufacturing Organic Electroluminescent Element

(71) Applicant: Toppan Printing Co., Ltd., Tokyo (JP)

(72) Inventors: Noritaka Mihashi, Tokyo (JP); Katsuyuki Kano, Tokyo (JP); Shunsuke Komuro, Tokyo (JP)

(73) Assignee: Toppan Printing Co., Ltd., Tokyo (JP)

(21) Appl. No.: 13/627,882

(22) Filed: Sep. 26, 2012

Related U.S. Application Data
(63) Continuation of application No. PCT/JP2011/054638, filed on Mar. 1, 2011.

(30) Foreign Application Priority Data
Mar. 31, 2010 (JP) 2010-082323

(51) Int. Cl. B41F 5/02; H05B 33/10

(52) U.S. Cl. 101/216; 101/483; 445/58

(57) ABSTRACT

A relief printing apparatus includes: a rotary plate cylinder; a relief plate disposed on the plate cylinder; an anilox roller of which a surface is subjected to unevenness processing and which supplies an ink to the relief plate; and a coating device which forms an ink coating film by applying the ink to a surface of the anilox roller. Furthermore, a printed matter is manufactured using the relief printing apparatus.

### CROSS-REFERENCE TO RELATED APPLICATION

This application is a continuation of International Application No. PCT/JP2011/054638, filed Mar. 1, 2011, which is incorporated herein by reference.

### BACKGROUND OF THE INVENTION

1. Field of the Invention

The present invention relates to a relief printing apparatus in which a fine pattern is able to be formed with in-plane uniformity on a body to be printed and with high positional accuracy using a relief printing method or a resin relief plate and the fine pattern is continuously and stably formed. In addition, the invention relates to a method of manufacturing a printed matter, which is appropriate for forming a high-precision pattern such as a pattern in a color filter for a liquid crystal display (LCD), a light-emitting layer or a charge transport layer of an organic electroluminescent (EL) element, an electrode pattern in an organic thin-film transistor (TFT) substrate, or a shield pattern in an electromagnetic shield.

2. Background Art

Hitherto, as a method of forming a fine pattern on a body to be printed with in-plane uniformity and with high positional accuracy using a wet process and continuously and stably forming the fine pattern, a photolithography method has been mainly used. However, in the photolithography method, the processes are complex, the manufacturing facilities and the like needed for pattern formation are expensive, and large amounts of material are wasted. Therefore, there is a problem in that manufacturing cost is increased.

In addition, as a patterning method other than the photolithography method, a printing method such as offset printing or relief printing, or an ink jet method has been actually attempted for thin-film pattern formation such as formation of a light-emitting layer of an organic EL element (JP-A-2001-93668 and JP-A-2001-155858). Particularly, it is thought that the relief printing method is advantageous in terms of patterning accuracy on a thin film.

An example of a relief printing apparatus according to the related art is described with reference to FIG. 13.

The relief printing apparatus of FIG. 13 includes a relief plate 704 having a relief pattern corresponding to a printing pattern, a rotary plate cylinder 705 to which the relief plate 704 is mounted with a block copy cushion 703 interposed therebetween, an anilox roller 701 for supplying ink to the plate surface of the relief plate 704, an ink chamber 708 which supplies the ink to the anilox roller 701, a doctor blade 702 which scrapes off the excess ink on the anilox roller, and a substrate surface plate 706 on which a substrate 707 to be printed is placed. The plate cylinder is rotated and the ink on the relief plate is transferred onto the substrate to be printed, thereby completing printing.

In the relief printing apparatus according to the related art as described above, as illustrated in FIG. 14, after the ink is supplied to the anilox roller 701 from the ink chamber 708, the doctor blade scrapes off the excess ink on an anilox roller surface 701A in order to uniformize the ink supplied to the plate from the anilox roller to a certain degree. In this manner, the amount of ink held by the anilox roller is adjusted.

However, the materials of the anilox roller and the doctor blade are made of metals in many cases due to accuracy and durability and both thereof always come in contact with each other during a printing process. Therefore, the surface of the blade or the anilox roller is gradually shaved and foreign matter is generated. In a case of a paper printed matter, there is no significant problem. However, in a case of electronics components such as semiconductors or color filters, product defects may be caused by the shaved foreign matter. In addition, in a case where the foreign matter is metal, there is a problem in that short circuits may occur due to electrical connection.

In addition, the amount of ink supplied to the surface of the relief plate is significantly dependent on, as well as the wettability of the plate surface, the pattern shape of the relief plate, and the ink viscosity, the number of mesh lines of the anilox roller and the cell volume of the mesh (the volume of the groove). In addition, due to an increase or decrease in the amount of ink supplied to the surface of the relief plate, the film thickness of the ink transferred onto the substrate to be printed which becomes the final product is increased or decreased.

On the other hand, as a relief printing method which does not use an anilox roller and a doctor blade, a printing apparatus which forms an ink coating film on a flat roller and supplies the ink coating film to a relief plate has been attempted (JP-A-2008-296547). However, unlike the anilox roller described above, film thickness control is not able to be achieved in the case of the flat roller. Therefore, control of the film thickness of the ink transferred onto the substrate to be printed is difficult and manufacturing of electronics components which require high film thickness accuracy and uniformity and the like is difficult. Particularly, as illustrated in FIG. 15, when ink is transferred to a relief plate 704 from a flat roller 710, an ink coating film 711 intrudes into the recessed portions of the relief plate and thus the printing pattern is crushed, resulting in difficulty in high-precision printing.

Moreover, there may be a method in which ink is collected in an ink chamber so as not to cause the ink on an anilox roller to be dried and the anilox roller is rotated so as to cause a part of the anilox roller to be immersed to achieve functions of ink application and drying prevention. In this method, the area of the ink that comes into contact with the atmosphere is large and the ink is easily oxidized and dried. Therefore, there is a problem in that dried foreign matter is generated.

The ink collected in the chamber gradually deteriorates due to the atmosphere during coating and even when the apparatus is stopped. Therefore, in order to maintain product quality, the ink needs to be regularly replaced, and thus a large amount of the ink is consumed for every replacement. Ink of electronics materials is expensive unlike ink for printing and thus requires running cost.

In addition, in the method according to the related art, a series of continuous operations in which, the anilox roller is rotated to pass the chamber and to be coated with the ink, and the ink is scraped off by the doctor blade and is transferred to the plate is performed. Therefore, the ink has to have a property of being simultaneously coated and transferred, and thus there is a problem in that ink selection is difficult.

### SUMMARY OF THE INVENTION

In order to solve the problems of the relief printing apparatus according to the related art as described above, an object of the invention is to provide a relief printing apparatus capable of forming a finer pattern on a body to be printed with in-plane uniformity and high positional accuracy by reducing the incorporation of foreign matter caused by a printing apparatus into a printing pattern, and a method of manufacturing a printed matter.

A first aspect of the present invention is a relief printing apparatus including:

a rotary plate cylinder;

a relief plate disposed on the plate cylinder;

an anilox roller including a surface subjected to unevenness processing, the surface supplying an ink to the relief plate; and

a coating device which forms an ink coating film by applying the ink to the surface of the anilox roller.

A second aspect of the present invention is a method of manufacturing a printed matter, which supplies an ink onto a relief plate from an anilox roller of which a surface is subjected to unevenness processing, and transfers the ink onto a substrate to be printed from the relief plate, the method comprising:

filling a recessed portion of the surface of the anilox roller with the ink and applying the ink to cover a protruding portion of the surface;

volatilizing the ink to increase a concentration of the ink on the anilox roller;

transferring the ink onto the relief plate from the anilox roller; and

transferring the ink onto the substrate to be printed from the relief plate.

According to the relief printing apparatus according to the invention, the anilox roller is not immersed into the ink chamber unlike in the related art, but the ink is directly applied to the anilox roller by the coating device. Therefore, the ink coating film is formed by adjusting the amount of ink, and thus it is possible to easily control the film thickness. In addition, using the anilox roller, it is possible to maintain film thickness stability and transferability of the plate constant.

In addition, since the drying controlling means for controlling the dried state of the ink coating film on the anilox film is provided, it is possible to control the film thickness and transferred state by controlling the application amount and drying time, and thus it is possible to control printing film thicknesses with high precision.

In addition, since the anilox roller cleaning mechanism is provided, the ink that remains on the anilox roller gradually or for a long-term suspension is cleaned and removed. Therefore, the anilox roller may be always maintained in a state of being coated and transferred, and thus it is possible to prevent the generation of dried foreign matter of ink.

In addition, since the plate cleaning mechanism is provided, it is possible to clean and remove the ink collected on the plate and the ink that adheres to the bottom of the pattern in each printing process, and thus the adhesion of foreign matter is able to be prevented. Therefore, it is possible to manufacture a high-quality printed matter.

Moreover, according to the method of manufacturing a printed matter according to the invention, the dried state of the ink coating film on the anilox roller is controlled without using the doctor blade to supply the ink to the anilox roller and transfer the ink to the relief plate. Therefore, it is possible to manufacture a printed matter in which foreign matter is barely incorporated and film thickness accuracy is excellent.

### BRIEF DESCRIPTION OF THE DRAWINGS

FIG. 1 is a schematic diagram of a configuration example of a relief printing apparatus of the invention.

FIG. 2A is a schematic diagram illustrating an ink coating film on an anilox roller surface immediately after an anilox roller is coated with ink by a coating device. FIG. 2B is a schematic diagram illustrating an ink coating film on the anilox roller surface when the ink is transferred onto a relief plate from the anilox roller.

FIG. 3 is a schematic diagram of anilox roller peripheral parts of the configuration example of the relief printing apparatus of the invention.

FIG. 4 is a schematic diagram of the anilox roller peripheral parts of the configuration example of the relief printing apparatus of the invention.

FIGS. 5A to 5C are schematic diagrams of the anilox roller surface for explaining the invention.

FIG. 6 is a schematic diagram of anilox roller peripheral parts of the configuration example of the relief printing apparatus of the invention.

FIG. 7 is a schematic diagram of anilox roller peripheral parts of the configuration example of the relief printing apparatus of the invention.

FIGS. 8A and 8B are schematic diagrams of the anilox roller peripheral parts of the configuration example of the relief printing apparatus of the invention.

FIGS. 9A to 9C are schematic diagrams of processes of a method of manufacturing a printed matter according to the invention.

FIGS. 10D and 10E are schematic diagrams of processes of the method of manufacturing a printed matter according to the invention.

FIGS. 11D′ and 11E′ are schematic diagrams of processes of the method of manufacturing a printed matter according to the invention.

FIG. 12 is a schematic diagram of a configuration example of an organic EL element according to the invention.

FIG. 13 is a schematic diagram of a relief printing apparatus according to the related art.

FIG. 14 is an enlarged schematic diagram of a contact part between an anilox roller surface and a doctor blade of the relief printing apparatus according to the related art.

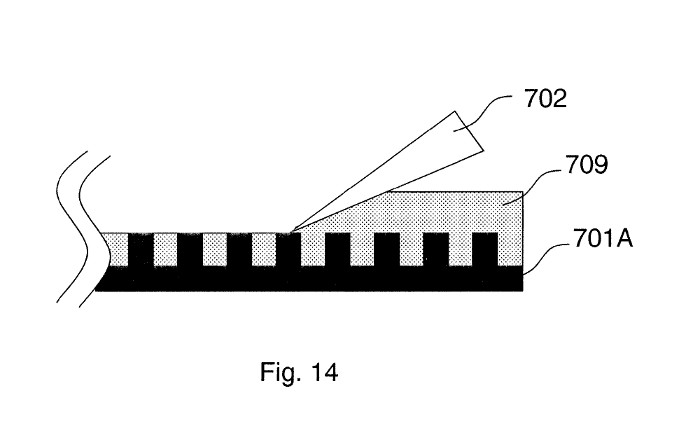

FIG. 15 is a schematic diagram of a relief printing method according to the related art.

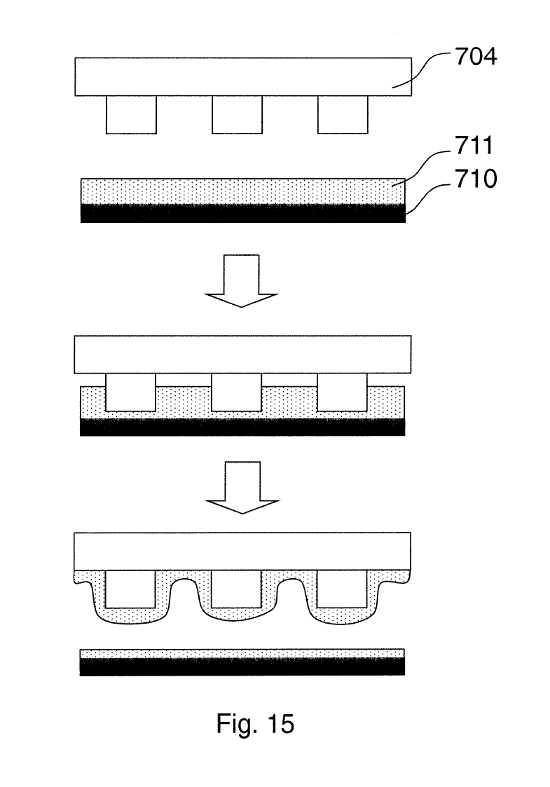

### DETAILED DESCRIPTION OF THE INVENTION

### Relief Printing Apparatus

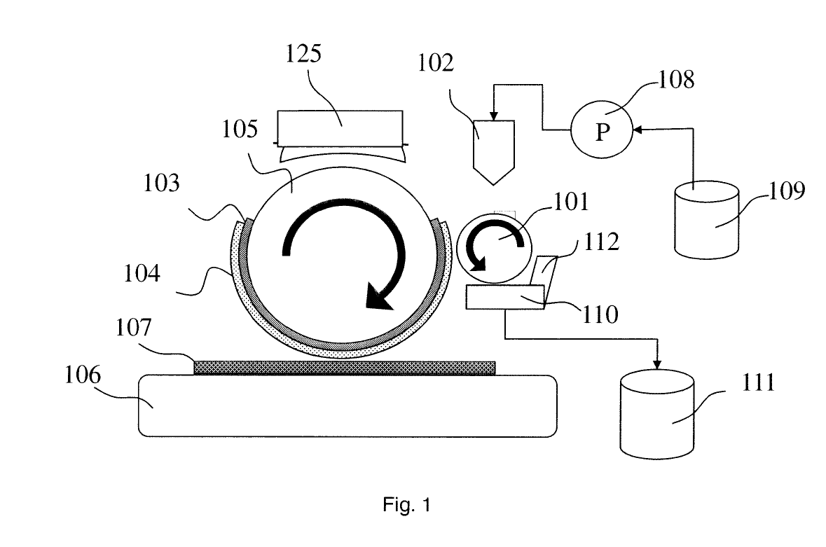

FIG. 1 is a schematic diagram of a configuration example of a relief printing apparatus of the invention.

The relief printing apparatus according to this embodiment includes a substrate surface plate 106 on which a substrate to be printed is disposed, a relief plate 104 which transfers the ink onto the substrate 107 to be printed, a rotary plate cylinder 105 to which the relief plate 104 is mounted directly or with a cushion 103 interposed therebetween, the substrate surface plate 106 for transporting the substrate 107 to be printed, an anilox roller 101 which transfers the ink onto the relief plate 104, and a coating device 102 which coats the anilox roller with the ink. In addition, although not shown, a controller which controls the components is provided. The configuration of the relief printing apparatus of the invention is not limited to the configuration illustrated in FIG. 1. For example, a form in which the substrate surface plate is moved below the plate cylinder may be employed, or a form in which the plate cylinder is moved above the substrate surface plate may be employed.

As the coating device 102 related to the relief printing apparatus of the invention, a device capable of uniformly forming a coating film on the anilox roller is preferable and is different from an ink chamber according to the related art in that the film thickness is controlled. Any form may be used as long as the device is able to coat the anilox roller 101 with a fixed amount of ink without contact. In the form illustrated in FIG. 1, coating nozzles that discharge the ink are disposed parallel to the rotating shaft of the anilox roller 101 so as to face an anilox roller surface and are able to form an ink coating film on the anilox roller 101. As the coating device, specifically, a slit coater may be employed. The slit coater 102 is a coating device which forms an ink coating film from the coating nozzles on the anilox roller 101 into a predetermined film thickness. The slit direction of the coating nozzles that discharge the ink of the slit coater is disposed parallel to the rotating shaft of the anilox roller 101 so as to face the surface of the anilox roller and thus is able to form an ink coating film on the anilox roller surface 101A.

In order to supply the ink to the coating device 102, a metering pump 108 is connected between an ink tank 109 and the coating device. The controller (not shown) connected to the metering pump 108 causes the pump to be in synchronization with the rotational speed of the anilox roller 101 so as to cause the metering pump 108 to send the ink for a designated film thickness at a coating rate at the rotational speed of the anilox roller 101, thereby controlling the amount of ink discharged from coating heads for coating. In this configuration, the ink for a designated film thickness may be accurately sent for each printing operation.

The ink discharge mechanism constituted by the coating device 102, the metering pump 108, and the ink tank 109 is configured as a closed system in which the ink does not come into contact with the air except for the tip ends of the coating nozzles of the coating device, and it is preferable to use nitrogen when the ink is pressurized and supplied to the pump. In a case where the printed matter is an electronic device, deterioration of ink that contains an organic functional material due to contact with the air is a problem. However, by blocking the air in such a manner, stable coating can be achieved without the deterioration of the characteristics of the ink.

As the anilox roller 101, a well-known general anilox roller may be used. Hitherto, the amount of ink supplied to the relief plate is controlled by selecting the number of mesh lines of the anilox roller and the cell volume of the mesh (the volume of the groove) so as to control the amount of ink transferred onto the substrate to be printed. However, according to the printing apparatus according to the invention, the controller controls the application amount and the dried state of the anilox roller to correspond to the characteristics of the ink, and thus the film thickness may be arbitrarily changed. Therefore, film thickness adjustment due to a change in the number of lines or the cell volumes of the anilox roller is not needed. In addition, a doctor blade is unnecessary. Therefore, incorporation of foreign matter due to the doctor blade is eliminated and thus it is possible to manufacture a high-quality printed matter.

According to the findings of the applicant of the invention, by causing the viscosity of the ink (second viscosity) when the ink is transferred onto the relief plate 104 from the anilox roller to be greater than the viscosity of the ink (first viscosity) when the anilox roller 101 is coated with the ink by the coating device 102, formation of the ink coating film on the anilox roller and transfer of the ink onto the relief plate are appropriately performed.

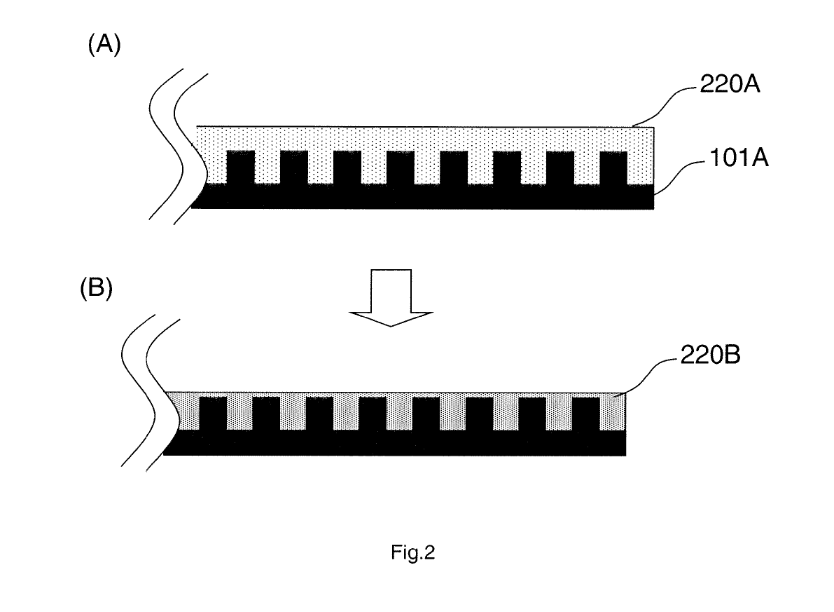

Therefore, it is preferable that the ink coated for a designated film thickness be dried (volatilization process) on the anilox roller 101 and be transferred onto the relief plate 104, then entering a state in which the ink is able to be transferred onto the relief plate 104. Here, the volatilization process is a process of changing film thickness and viscosity by volatilizing a part of the solvent from the ink and does not mean complete drying. FIG. 2A is a schematic diagram illustrating an ink coating film 220A on the anilox roller surface immediately after the anilox roller is coated with the ink by the coating device 102. The ink discharged onto the anilox roller 101 from the coating nozzles of the coating device 102 is coated at an ink density (the proportion of a medium) which achieves a viscosity at which the ink completely fills the cells of the anilox roller surface. It is preferable that the first viscosity of the ink during the coating be higher than or equal to 1 mPa·s and less than or equal to 15 mPa·s for forming a uniform ink film thickness on the anilox roller surface 101A. When the first viscosity is less than 1 mPa·s, the ink moves to the anilox roller surface 101A as the anilox roller is rotated and thus there is a concern of the ink film thickness becoming non-uniform. In addition, in a case of a viscosity of higher than 15 mPa·s, there is a concern of the ink not being uniformly leveled on the anilox roller surface 101A during the coating of the anilox roller by the coating device.

FIG. 2B is a schematic diagram illustrating an ink coating film 220B on the anilox roller surface when the ink is transferred onto the relief plate 104 from the anilox roller 101. According to the printing apparatus and the method of manufacturing a printed matter according to the invention, by controlling the dried state of the ink coating film 220B, it is possible to arbitrarily change the film thickness and viscosity of the ink. In the stage of FIG. 2B, the ink concentration is increased due to the volatilization of the solvent of the ink and accordingly the viscosity is increased. In particular, it is preferable that the second viscosity of the ink during the transfer onto the relief plate be higher than or equal to 30 mPa·s and less than or equal to 100 mPa·s. When the second viscosity is less than 30 mPa·s, there is a concern of the ink flowing into the recessed portions of the relief plate. Therefore, in consideration of transfer characteristics on the substrate to be printed from the relief plate, a viscosity of higher than or equal to 30 mPa·s is preferable. In addition, when the second viscosity is higher than 100 mPa·s, there is a concern of the ink remaining on the anilox roller 101 during transfer, resulting in an unstable transfer amount.

As drying controlling means for controlling the dried state as described above, a time for the solvent to naturally volatilize by stopping the rotation of the anilox roller may be provided. In addition, the volatilization of the solvent may be accelerated by generating an air current toward the surface of the ink coating film and reducing the partial pressure of the solvent in the periphery of the anilox roller surface 101A. Specifically, rotating the anilox roller or a blowing mechanism that blows a gas such as the air or an inert gas may be provided as a drying mechanism 113. As a configuration example of another drying mechanism 113 according to the invention, there is a mechanism provided with a heating mechanism such as an infrared irradiation device or a far-infrared irradiation device. In order to uniformly heat the ink coating film and not to damage ink materials, far-infrared rays are preferable. In addition, as described later, a suction mechanism which surrounds the periphery of the ink coating film and suctions the air in the periphery to achieve a low pressure (including vacuum), thereby accelerating drying, or the like may be employed.

As described above, in order to control the dried state of the ink coating film by rotating the anilox roller or providing the drying mechanism, the anilox roller 101 and the relief plate 104 are not in an asynchronous state. In the asynchronous state, the plate cylinder 105 (relief plate) and the anilox roller may be separated from a contact state.

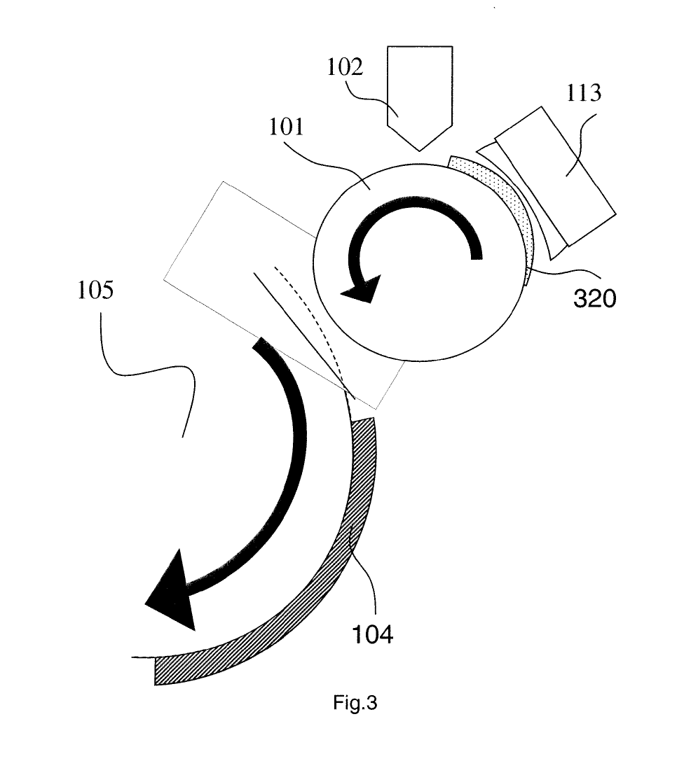

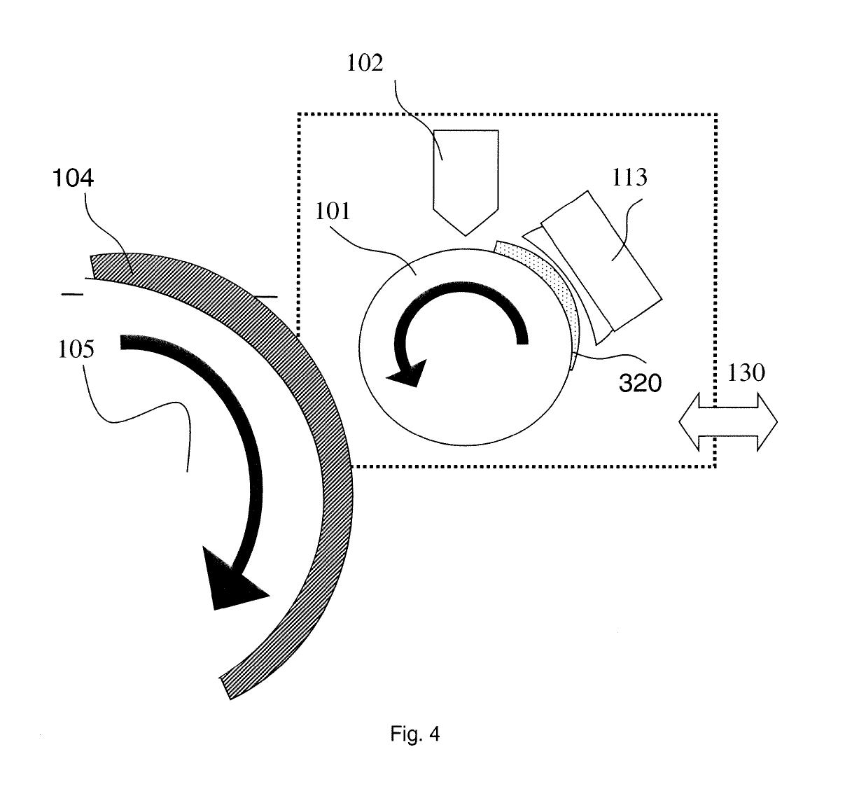

In the relief printing apparatus of the invention, as described above, as a configuration that separates the plate cylinder 105 (relief plate) and the anilox roller from the contact state, as illustrated in FIG. 3, a part of the plate cylinder may be provided with a region where the plate cylinder 105 (relief plate) does not come into contact with the anilox roller. In the form of the invention of FIG. 3, a cut-out portion is provided in the plate cylinder. Otherwise, as in FIG. 4, a form in which an anilox roller moving mechanism 130 which mechanically moves the distance between the plate cylinder 105 and the anilox roller 101 is provided and the moving mechanism is connected to the controller may be employed. A configuration in which the relief plate and the anilox roller are automatically separated during a drying process and are automatically caused to abut on each other during a process of transferring ink onto the relief plate by the command from the controller may be employed.

When the anilox roller moving mechanism 130 is provided, with an arrangement which opposes the anilox roller 101 at least at a predetermined anilox roller moving position, the ink coating film 320 may be aligned with a region opposing the drying mechanism 113 by rotating the anilox roller. Therefore, a position at which the anilox roller and the drying mechanism oppose each other is arbitrary. For example, in the form of FIG. 3, the anilox roller mechanism 130 is arranged to oppose the anilox roller 101 on the opposite side to a position that abuts on the relief plate 104 with respect to the coating device 102. This arrangement has an advantage that the anilox roller moving mechanism 130 may also be used as a part of an anilox roller cleaning mechanism. The anilox roller moving mechanism 130 may be a mechanism that moves the coating device 102 and the drying mechanism 113 integrally with each other or may also move only the anilox roller 101. However, the mechanism that moves the coating device 102 and the anilox roller 101 integrally with each other is preferable for ink coating stability.

On the other hand, in a case where ink concentration is adjusted on the anilox roller, due to a difference in concentration between the ink that is not transferred onto the relief plate 104 and remains after the previous printing and the ink that is newly supplied from the coating device 102, there is a concern that the ink concentrations may vary and the state of ink transferred onto the relief plate may not be maintained constant.

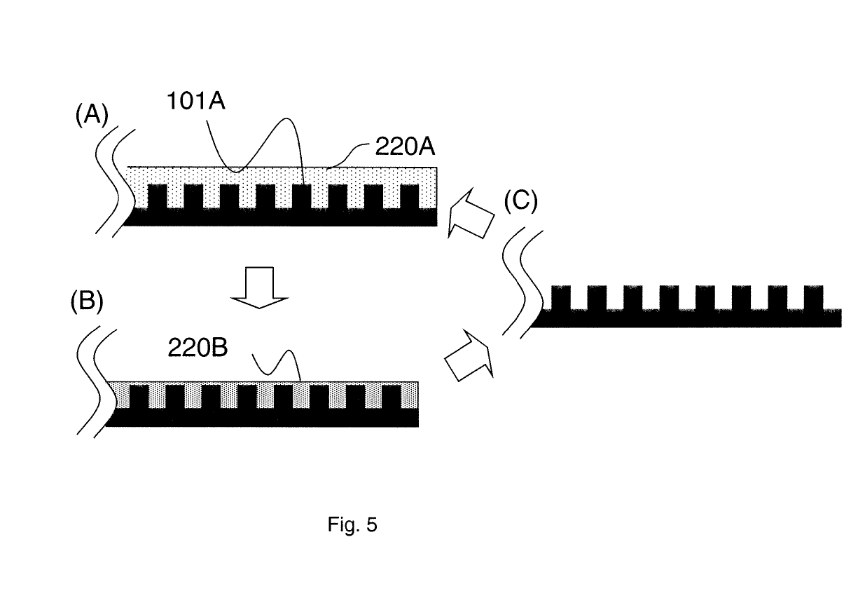

Here, in the relief printing apparatus of the invention, an anilox cleaning mechanism 114 for cleaning the anilox roller 101 for each printing process may be provided. Between the process of transferring the ink onto the relief plate 104 and the process of supplying the ink onto the anilox roller again, a process of cleaning the anilox roller is provided, thereby removing variations in ink concentrations. That is, a cycle of ink supply to the anilox roller (FIG. 5A), ink transfer onto the relief plate (FIG. 5B), ink removal from the anilox roller surface 101A (FIG. 5C), and ink supply to the anilox roller (FIG. 5A) is made, and thus the ink state may be appropriately maintained.

The anilox roller cleaning mechanism 114 according to the invention includes an anilox roller cleaning unit 112 that has cleaning liquid discharge means for discharging at least a cleaning liquid toward the anilox roller surface to wash the ink away and cleaning liquid removing means for removing the cleaning liquid, and an ink recovery unit 110 that recovers the washed ink and the cleaning liquid. It is preferable that the anilox roller cleaning unit 112 has a configuration that does not come into contact with the anilox roller except for the cleaning liquid for preventing damage of the anilox roller and incorporation of foreign matter.

As the cleaning liquid that cleans the anilox roller 101, a volatile organic solvent that has a property of being dissolved in a medium in the ink (ink material) is preferable. When water or a detergent is mixed, there is a concern that the characteristics of the ink may be adversely affected in a case of remaining on the anilox roller surface. In addition, since the volatile organic solvent is used, it is possible to remove the cleaning liquid from the anilox roller 101 by spraying a pressurized gas so as not to cause the cleaning liquid to remain. Particularly, so as not to adversely affect the characteristics of the ink, it is preferable that the same organic solvent as the ink solvent or an organic solvent made by mixing one or several organic solvents that are contained in the ink solvent and easily volatilize be used as the cleaning liquid.

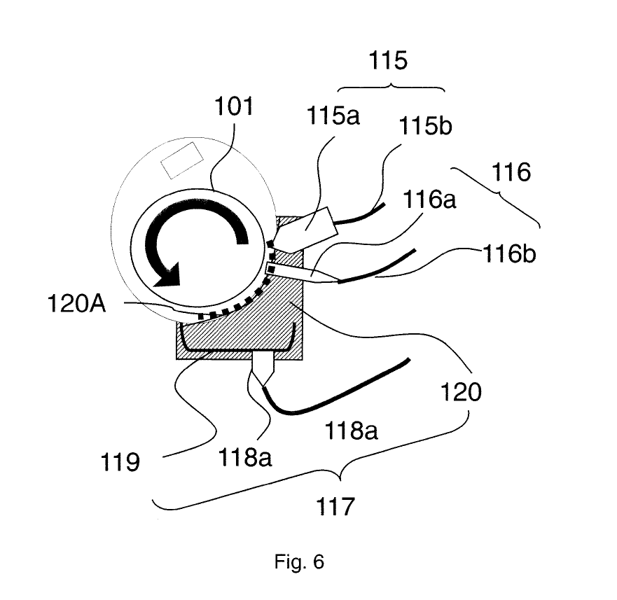

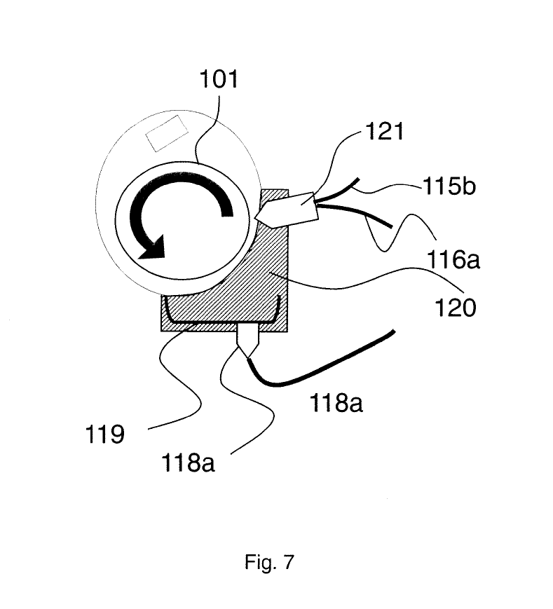

Hereinafter, a configuration example of the anilox roller cleaning mechanism 114 is illustrated in more detail with reference to FIGS. 6 and 7, and the embodiment of the invention is not limited to such a configuration.

FIG. 6 is a schematic diagram of the anilox roller cleaning mechanism 114 of the relief printing apparatus according to the invention. The cleaning mechanism 114 illustrated in FIG. 6 includes a cleaning liquid supply unit 116 that supplies at least the cleaning liquid to the anilox roller surface, a cleaning liquid recovery unit 117 that recovers the cleaning liquid supplied to the anilox roller surface so as not to scatter, and a blowing unit 115 that dries and removes the cleaning liquid from the anilox roller surface. The cleaning mechanism 114 in the embodiment of FIG. 6 is installed in a region that is behind the position where the anilox roller 101 and the relief plate abut on each other and is in front of the position where the anilox roller and the coating device 102 oppose each other with respect to the rotational direction (the arrow in the figure) of the anilox roller.

As a form of the cleaning liquid spraying nozzles 116, a form in which the cleaning liquid spraying nozzles 116 are parallel at equal intervals in the width direction of the anilox roller 101 (a direction parallel to the rotating shaft), a form in which the cleaning liquid spraying nozzles are moved in the width direction of the anilox roller, and a slit nozzle form in which the cleaning liquid is able to be uniformly supplied in the width direction of the anilox roller may be considered. In addition, in order to scrape off ink residues collected in the recessed portions (cells) of the anilox roller, two-fluid nozzles that spray the cleaning liquid together with the pressurized gas may be employed. In addition, regarding the spraying direction of the cleaning liquid spraying nozzles 116, similarly, in order to scrape off ink residues collected in the recessed portions of the anilox roller, an arrangement at an angle at which the spraying direction goes straight to the anilox roller surface or at an angle inclined downward is efficient.

Next, the blowing unit 115 blows away or volatilizes the cleaning liquid on the anilox roller 101 due to the cleaning liquid supply unit 116, thereby removing the cleaning liquid. According to the form illustrated in FIG. 6, a gas supplying nozzle 115a that sprays the pressurized gas toward the surface of the anilox roller to which the cleaning liquid is supplied is provided, and the gas spraying nozzle is connected to a pressurized gas supply hose 115b, thereby supplying the pressurized gas from the pressurized gas supply hose. As the pressurized gas for use, the air or an inert gas such as nitrogen or a noble gas is preferable. In the form of FIG. 6, in order to remove the cleaning liquid after the cleaning liquid is supplied to the anilox roller, regarding the cleaning liquid spraying nozzles, with respect to the rotational direction of the anilox roller, the gas spraying nozzles are arranged at a position close to the coating position of the anilox roller 101 by the coating device 102.

As another form of the invention, like an anilox roller cleaning mechanism illustrated in FIG. 7, a nozzle that sprays the cleaning liquid toward the surface of the anilox roller 101 and a nozzle that sprays the pressurized gas toward the anilox roller after the cleaning liquid is supplied are configured as a single common nozzle 121, and a cleaning liquid supply hose 116a and a pressurized gas supply hose 115b may be configured to be respectively connected to the common nozzle. The cleaning liquid and the pressurized gas may be switched by the common nozzle so as to be sprayed toward the anilox roller. In this case, when the pressurized gas is sprayed for drying after the cleaning liquid is sprayed from the common nozzle, droplets of the cleaning liquid that remain at the tip end of the common nozzle are blown away at the same time. Therefore, defects caused by cleaning unevenness due to dripping of cleaning liquid droplets to the anilox roller from the tip end of the common nozzle may be prevented.

Next, as illustrated in FIG. 6, the cleaning liquid recovery unit 117 includes a cleaning liquid recovery tray 119 and a suction port 118 that communicates with the bottom portion of the tray 119, and the suction port is configured to be connected to a suction hose so as to cause the cleaning liquid to be recovered by the ink recovery tank 111 connected to the suction hose. Since the ink is dissolved in the recovered cleaning liquid, it is possible to recycle and reuse the ink. Therefore, an expensive ink material is not wasted and cost may be reduced.

Moreover, the anilox roller cleaning mechanism 114 according to the invention includes a cleaning mechanism cover 120 which accommodates the cleaning liquid spraying nozzle and the gas spraying nozzle or the common nozzle, and the tray 119. A part of the cover 120 corresponding to the outer peripheral curve of the anilox roller 101 is formed in a curved shape corresponding to the outer peripheral curve of the anilox roller, and a curved shape part 120A of the cleaning mechanism cover 120 is open. The nozzles of the blowing unit and the cleaning liquid supply unit and the cleaning liquid recovery unit 117 are covered by the cleaning mechanism cover 120. Therefore, it is possible to perform the cleaning process without scattering the cleaning liquid and prevent incorporation of foreign matter. It is preferable that the gap between the outer peripheral curve of the anilox roller and the curved shape part 120A be smaller than or equal to 5 mm. In addition, as illustrated in FIG. 4, the cleaning liquid supply nozzle and the gas spraying nozzle are caused to face the opening of the curved shape part and are arranged before and after in the rotational direction of the anilox roller.

In addition, since the cleaning mechanism cover 120 covers a region of the anilox roller as described above, the air in the periphery is suctioned by the suction port 118 of the cleaning liquid recovery unit 117 or a suction nozzle that is additionally provided so as to cause the corresponding region to be in a low-pressure state. In this configuration, volatilization and removal of the cleaning liquid may be accelerated during the cleaning process. In addition, the cleaning mechanism cover 120 may also be used as a drying controlling means for controlling the dried state of the ink film coated on the anilox roller surface. That is, the cleaning mechanism cover 120 may also serve as the drying mechanism 113. Otherwise, the cleaning mechanism cover 120 serves as the cover that covers a region of the anilox roller surface and the drying mechanism 113 provided with the suction nozzle so as to be used as a cleaning liquid removing means for removing the cleaning liquid. As the cleaning liquid removing means, the drying mechanism 113 may be simply used, or a configuration including the blowing unit 115 may be employed for a combined use.

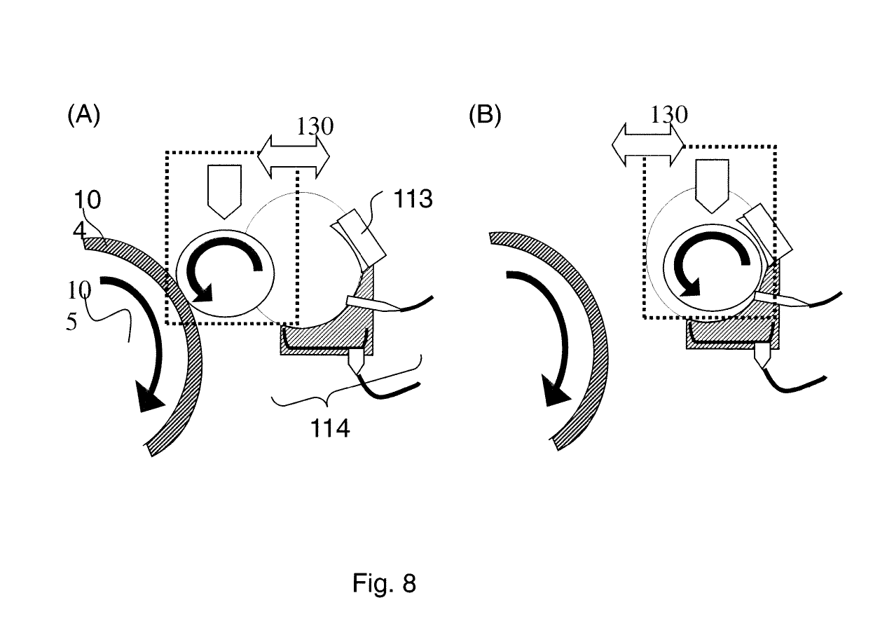

Regarding the relationship with the anilox roller moving mechanism 130, when the drying mechanism 113 and the cleaning mechanism 114 are arranged to be separated from each other as illustrated in FIG. 8A and are moved to an operation position from the plate cylinder side using the moving mechanism 130 (FIG. 8B), it is easy to use both the functions of the drying mechanism 113 and the cleaning mechanism 114.

Moreover, in order to maintain the characteristics of the ink constant, a plate cleaning unit 125 for cleaning the relief plate 104 may be provided at a predetermined interval. The plate cleaning unit 125 may use the same configuration as the anilox roller cleaning mechanism 114. In addition, a mechanism that moves the plate cylinder and the anilox roller relative to the anilox roller cleaning mechanism 114 may be provided for a combined use of the cleaning unit and the cleaning liquid recovery unit.

In addition, as a configuration that closes the entirety of the relief printing apparatus of the invention, the inside of the apparatus may be filled with an inert gas such as nitrogen. Many ink materials used for electronics products are oxidized by reacting with oxygen in the atmosphere, and it is thought that problems such as the degradation in product characteristics occur due to the deterioration of the ink materials. By filling the configuration closed by covering the entire apparatus with the cover with an inert gas such as nitrogen, and thus reducing the oxygen concentration in the periphery of the apparatus, the oxidation of the ink is suppressed, thereby preventing the deterioration of the characteristics of printed products. In addition, since the ink is not oxidized, it is easy to recycle and reuse the ink from the recovered cleaning liquid. In addition, a configuration in which the entire apparatus is closed and is connected to a vacuum pump to perform printing in a vacuum or in a low-pressure state in which the air is replaced with an inert gas may be employed.

### Method of Manufacturing Printed Matter

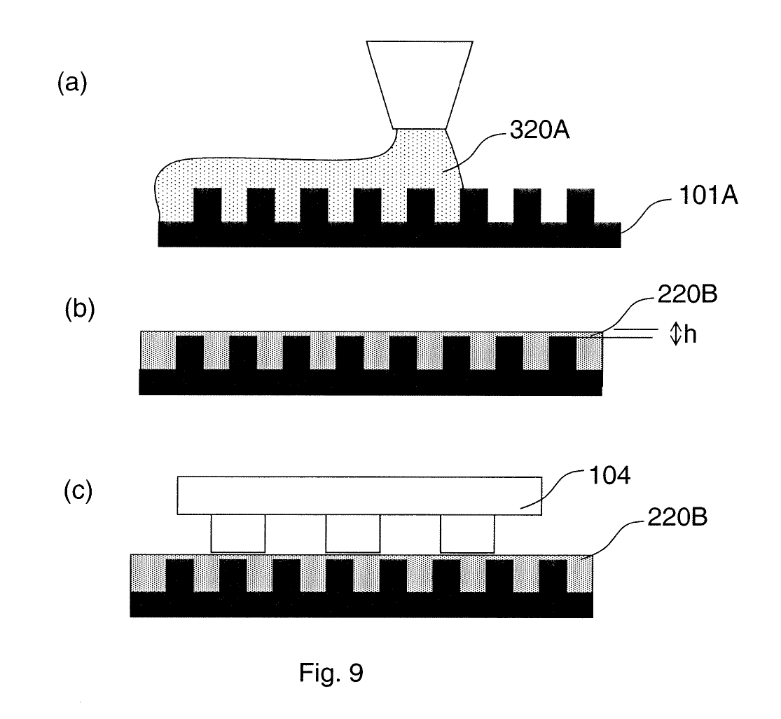

Next, the method of manufacturing a printed matter according to the invention will be described with reference to FIGS. 9A to 11E′.

First, as a process of supplying ink to the anilox roller 101, the recessed portions (cells) of the anilox roller surface are filled with the ink, and an ink coating film is formed to cover the protruding portions (FIG. 9A). As described above, by causing the rotational speed of the anilox roller 101 and the amount of ink discharged from the coating device to be in synchronization with each other, it is possible to control the film thickness of the anilox roller surface and form the ink coating film.

Next, in order for an ink coating film 220A on the anilox roller to be in an appropriate dried state to be transferred onto the relief plate, apart of the ink solvent is volatilized from the anilox roller to change the first viscosity to the second viscosity (FIG. 9B). As a volatilization process, as described above, well-known drying methods such as natural drying, drying by heating, and vacuum (low-pressure) drying may be used. The film thickness of an ink coating film 220B on the anilox roller surface 101A when the ink is transferred onto the relief plate 104 is dependent on the relief depth or pattern of the relief plate, and it is preferable that a film thickness h from the protruding portion of the anilox roller surface be smaller than or equal to 1/10 of the cell depth. When the film thickness h becomes greater than 1/10 of the cell depth, there is a concern that the amount of ink supplied to the ink protruding portion may not be stable, or there is a concern that the ink may intrude into the recessed portions of the relief plate as in the flat roller. In addition, it is preferable that the liquid surface of the ink coating film in the cell have a height of higher than or equal to the height of the protruding portion of the anilox roller surface so as to come into contact with the protruding portion of the relief plate, that is, h≧0.

As described above, after achieving the appropriate ink coating film 220B state for the transfer process of transferring the ink onto the relief plate 104 from the anilox roller 101, the rotational speed of the anilox roller is caused to be in synchronization with the plate cylinder 105 provided with the relief plate and the anilox roller is rotated in a range corresponding to the relief pattern region formed on the relief plate, thereby transferring the ink from the anilox roller onto the relief plate (primary transfer) (FIG. 9C).

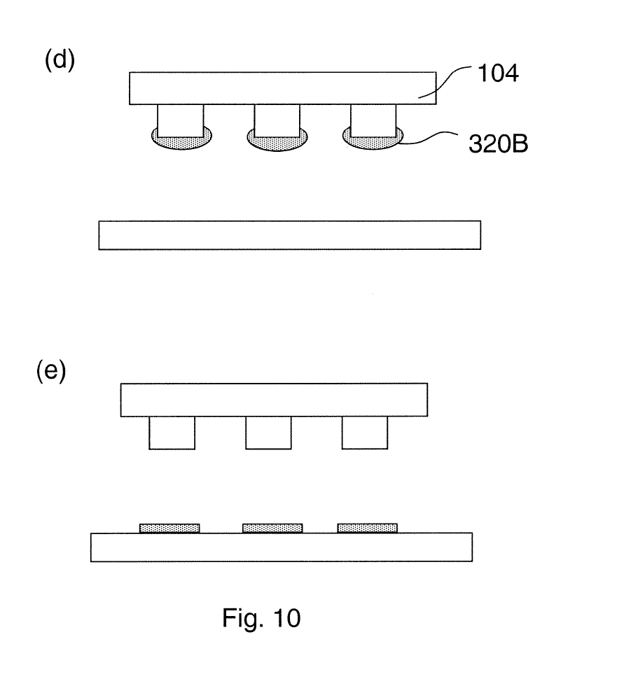

Next, simultaneously, the plate cylinder and the substrate surface plate 106 on which the substrate 107 to be printed is installed are in synchronization with each other, the relief plate is caused to come into contact with the substrate 107 to be printed and is rotated, and thus the ink pattern corresponding to the relief pattern is transferred onto the substrate to be printed (secondary transfer), thereby forming the ink pattern on the substrate to be printed (FIGS. 10D and 10E).

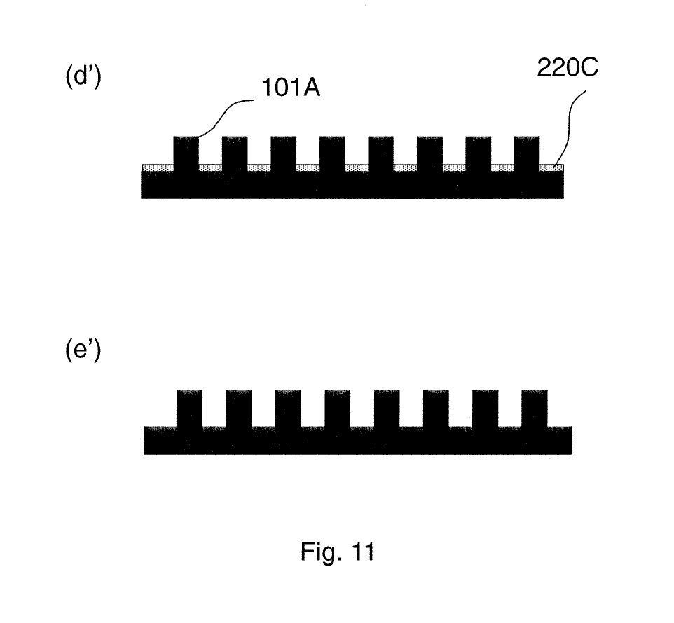

Before and after the secondary transfer process, as illustrated in FIGS. 11D′ and 11E′, an anilox roller cleaning process may be provided. As described above, when the moving mechanism 130 is provided for the anilox roller 101 and cleaning is performed in a state of being separated from the relief plate, operations may be performed in parallel. First, the anilox roller 101 is further rotated, and a region in which an ink 220C remains on the anilox roller surface is moved to the cleaning mechanism 114. At this time, printing may be continuously performed in a state where the anilox roller and the plate cylinder are in synchronization with each other, or cleaning may be performed by rotating only the anilox roller in an asynchronous manner.

Next, the anilox roller 101 is further rotated, and cleaning of the anilox roller is completed to a point at which an ink coating film is newly formed on the anilox roller surface by the coating device, and thus a new ink may be applied in a state where the ink and the cleaning liquid are completely removed from the anilox roller surface.

As such, a single printing process is completed. Since the ink is removed from the anilox roller every single process and the film thickness is maintained without the doctor blade, it is possible to manufacture a high-quality printed matter in which printing characteristics are maintained even after repeated printing operations.

### Method of Manufacturing Organic EL Element

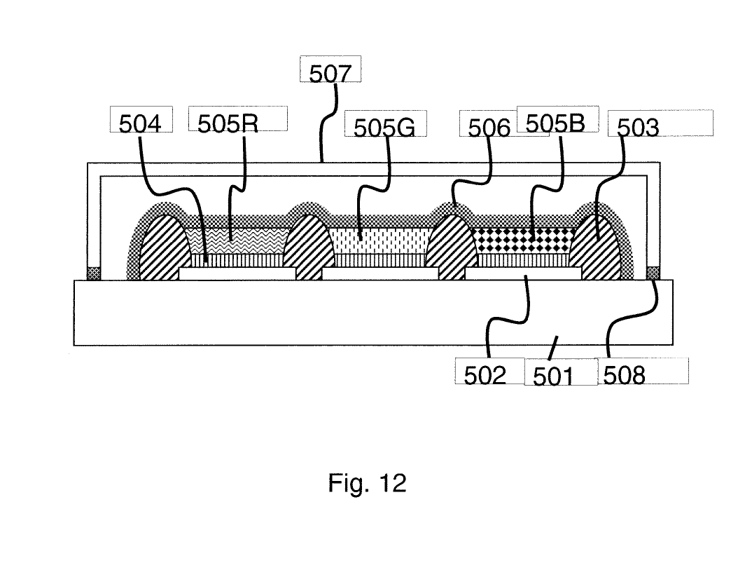

An example of applying the embodiment of the method of manufacturing a printed matter of the invention to an organic EL element will be described with reference to FIG. 12 that illustrates a configuration example of the organic EL element. A method of driving the organic EL element includes a passive matrix type and an active matrix type, and the organic EL element of the invention may be applied to any of a passive matrix type organic EL element and an active matrix type organic EL element.

The passive matrix type is a type in which stripe-shaped electrodes orthogonally oppose each other to cause the intersections thereof to emit light, and the active matrix type is a type in which a so-called thin-film transistor (TFT) substrate having transistors formed for each pixel is used to cause each pixel to individually emit light.

In a case where the organic EL element is a bottom emission type organic EL element in which light is taken out from the substrate side, a transparent substrate needs to be used. However, in a case of a top emission type in which light is taken out from the opposite side to a substrate, the substrate does not need to have transparency.

As a substrate 501, a glass substrate or a plastic film or sheet may be used. When the plastic film is used, it is possible to manufacture a polymer EL element through winding, and thus a display panel may be provided with low cost. In addition, as the plastic in this case, for example, polyethylene terephthalate, polypropylene, a cycloolefin polymer, polyamide, polyethersulfone, polymethylmethacrylate, polycarbonate, or the like may be used. In addition, such a film is provided with a barrier layer made of a metal oxide such as a silicon oxide that exhibits water vapor barrier properties and oxygen barrier properties, an oxynitride such as a silicon nitride, polyvinylidene chloride, polyvinyl chloride, or a saponified ethylene-vinyl acetate copolymer as necessary.

In addition, on the substrate 501, a pixel electrode 502 patterned as an anode is provided. As the material of the pixel electrode 502, a transparent electrode material such as ITO (an indium tin composite oxide), IZO (an indium zinc composite oxide), a tin oxide, a zinc oxide, an indium oxide, or an aluminum oxide composite oxide may be used. In addition, ITO is preferable because of low resistance, solvent resistance, and transparency. ITO is formed on the substrate by a sputtering method and is patterned by a photolithography method, thereby forming the line-shaped pixel electrode 502.

In addition, after forming the line-shaped pixel electrode 502, an insulating layer 503 is formed by the photolithography method using a photo-sensitive material between the adjacent pixel electrodes.

It is preferable that the insulating layer 503 in this embodiment has a thickness in a range of 0.5 μm to 5.0 μm. In addition, by providing the insulating layer between the adjacent pixel electrodes, spreading of a hole transport ink printed on each pixel electrode is suppressed, and thus generation of a leakage current because of a hole transport layer provided on the insulating layer during a display may be prevented. In addition, when the insulating layer is too low, spreading of the ink may not be prevented and the hole transport layer is formed on the insulating layer.

In addition, for example, in the passive matrix type organic EL element, in a case where the insulating layer is provided between the pixel electrodes, a cathode layer is formed to go straight to the insulating layer. In the case where the cathode layer is formed over the insulating layer as described above, when the insulating layer is too high, a short circuit of the cathode layer occurs, resulting in display defects. When the height of the insulating layer is higher than 5.0 μm, a short circuit of the cathode easily occurs.

In addition, the photo-sensitive material that forms the insulating layer 503 may be any of a positive type resist and a negative type resist or may be a commercialized product but has to have insulating properties. In addition, in a case where a partition wall does not have sufficient insulating properties, current may flow between adjacent pixel electrodes through the partition wall, resulting in display defects. Specifically, the photo-sensitive material may be a polyimide-based, acrylic resin-based, novolak resin-based, or fluorene-based material and is not limited thereto. In addition, for the purpose of enhancing the display quality of the organic EL element, a material having light-shielding properties may be contained in the photo-sensitive material.

In addition, the photo-sensitive resin that forms the insulating layer 503 is applied using an application method such as spin coating, bar coating, roll coating, die coating, or gravure coating and is patterned by the photolithography method. In addition, without using the photo-sensitive resin, the insulating layer may be formed using a gravure offset printing method, a reverse printing method, a relief printing method, or the like.

After forming the insulating layer 503 as described above, a hole transport layer 504 is then formed. As a hole transport material that forms the hole transport layer 504, a polyaniline derivative, a polythiophene derivative, a polyvinyl carbazole (PVK) derivative, poly(3,4-ethylenedioxythiophene) (PEDOT), or the like may be employed. Such a material is dissolved and dispersed in a solvent so as to obtain a hole transport material ink and may be formed using the relief printing method according to this embodiment.

Examples of the solvent that dissolves and disperses the hole transport material include toluene, xylene, acetone, methyl ethyl ketone, methyl isobutyl ketone, cyclohexanone, methanol, ethanol, isopropanol, ethylene glycol, propylene glycol, polyethylene glycol, glycerin, ethyl acetate, butyl acetate, isopropyl acetate, methyl cellosolve acetate, ethyl cellosolve acetate, methyl cellosolve, ethyl cellosolve, butyl cellosolve, ethyl lactate, ethylene glycol diethyl ether, 1-propanol, methoxypropanol, ethoxypropanol, and water, which are used singly or in combinations as a mixed solvent. In addition, as necessary, a surfactant, an antioxidant, a viscosity modifier, an ultraviolet absorber, or the like may be added.

In addition, it is preferable that the solid content concentration of the hole transport layer ink be 0.5 to 4.0%. This is because the hole transport ink used in this embodiment, which has a concentration of higher than or equal to 4.0%, has poor ink stability, resulting in ink agglomeration or the unevenness of the hole transport layer.

In addition, an inorganic material may be used for the hole transport layer 504. As the inorganic material, an inorganic compound that includes one or more kinds of a transition metal oxide such as Cu₂O, Cr₂O₃, Mn₂O₃, FeOₓ (x˜0.1), NiO, CoO, Pr₂O₃, Ag₂O, MoO₂, Bi₂O₃, ZnO, TiO₂, SnO₂, ThO₂, V₂O₅, Nb₂O₅, Ta₂O₅, MoO₃, WO₃, and MnO₂, a nitride thereof, and a sulfide thereof. As a method of forming the inorganic material hole transport layer, depending on the material, existing film formation methods including a dry film formation method such as a resistance heating vapor deposition method, an electron beam vapor deposition method, a reactive vapor deposition method, an ion plating method, or a sputtering method, and a wet film formation method such as a spin coating method or a sol-gel method may be used.

Next, after forming the hole transport layer 504 as described above, organic light-emitting layers 505 are formed. The organic light-emitting layer is a layer that emits light as current passes therethrough, and examples of an organic light-emitting material that forms the organic light-emitting layer include a material in which a light-emitting pigment such as a coumarin-based, perylene-based, pyran-based, anthrone-based, porphyrin-based, quinacridone-based, N,N′-dialkyl-substituted quinacridone-based, naphthalimide-based, N,N′-diaryl-substituted pyrrolopyrrole-based, or iridium complex-based pigment is dispersed in a polymer such as polystyrene, polymethylmethacrylate, or polyvinyl carbazole, and a polymer material such as a polyarylene-based, polyarylene vinylene-based, or polyfluorene-based material.

Such an organic light-emitting material is dissolved or stably dispersed in a solvent, thereby obtaining an organic light-emitting ink. As the solvent that dissolves or disperses the organic light-emitting material, there are toluene, xylene, acetone, anisole, methyl ethyl ketone, methyl isobutyl ketone, and cyclohexanone, which are used singly or in combinations as a mixed solvent. Particularly, an aromatic organic solvent such as toluene, xylene, or anisole is appropriate in terms of the solubility of the organic light-emitting material. In addition, as necessary, a surfactant, an antioxidant, a viscosity modifier, an ultraviolet absorber, or the like may be added to the organic light-emitting ink.

In a case where a relief printing method is used as a method of forming the organic light-emitting layer 505, a resin relief plate appropriate for the organic light-emitting ink may be used, and particularly, a water development type photo-sensitive resin relief plate is appropriate. As illustrated in FIG. 12, in a case where the organic light-emitting layers 505R, 505G, and 505B are separately applied in different colors so as to correspond to, for example, RGB light-emitting colors, the manufacturing method of the invention capable of forming a high-precision pattern is appropriate.

Next, after forming the organic light-emitting layer 505 as described above, a cathode layer 506 is formed in a line pattern orthogonal to the line pattern of the pixel electrode. As the material of the cathode layer 506, a material corresponding to the light-emitting characteristics of the organic light-emitting layer may be used. Examples of the material include a metal single body such as lithium, magnesium, calcium, ytterbium, or aluminum and an alloy of the metal single body and a stable metal such as gold or silver. In addition, a conductive oxide such as indium, zinc, or tin may be used. As a method of forming the cathode layer, a formation method according to a vapor deposition method using a mask may be employed.

In addition, the organic EL element of this embodiment has a configuration in which the hole transport layer and the organic light-emitting layer are laminated from the anode layer side between the pixel electrode which is the anode and the cathode layer. However, the organic light-emitting layer that contributes to light emission may be provided at least between the cathode layer and the anode layer. A structure in which light-emitting medium layers including a hole blocking layer, an electron transport layer, and an electron injection layer are selectively laminated as necessary between the anode layer and the cathode layer besides the hole transport layer and the organic light-emitting layer may be employed. In addition, when such layers are formed, the formation method of the invention may be used.

Last, in order to protect such an organic EL construction from oxygen or moisture on the outside, the organic EL construction may be closed and sealed using a glass cap 507 and an adhesive 508 so as to obtain the organic EL element. In addition, in a case where the substrate has flexibility, sealing may be performed using a sealant and a flexible film.

As described above, as an example of a printed body, an example of applying the method of manufacturing a printed matter of the invention to formation of the organic light-emitting layer and the light-emitting medium layer in the organic EL element is illustrated. However, besides the organic EL element, the method of manufacturing a printed matter of the invention is appropriate for forming a very thin film pattern with high precision, such as a pattern in a color filter for a liquid crystal display (LCD), a light-emitting layer or a charge transport layer of an organic electroluminescent (EL) element, an electrode pattern or a semiconductor layer pattern in an organic thin-film transistor (TFT) substrate, or a shield pattern in an electromagnetic shield, and the like.

### EXAMPLES

Next, specific examples in which organic EL elements were manufactured using the relief printing apparatus of the invention are described.

### Example 1

### Relief Printing Apparatus

An apparatus configuration (the embodiment of the invention) used in this example is the same as the configuration illustrated in FIG. 1, and includes a rotary plate cylinder 105 to which a relief plate for pattern formation is mounted with a block copy cushion 103 interposed therebetween, a substrate surface plate 106 on which a substrate 107 to be printed is placed, an anilox roller 101 for supplying ink to the relief plate 104, a slit coater 102 for applying the ink to the anilox roller, a metering pump 108 which sends the ink to the slit coater, an ink tank 109 which supplies the ink to the metering pump, an ink recovery unit 110 and a recovery tank 111 for recovering the ink and a cleaning liquid on the anilox roller, an anilox roller cleaning unit 112 for cleaning the anilox roller, a plate cleaning unit 125 which cleans the relief plate, and a controller (although not shown) which controls the above components.

In addition, the relief plate 104 has a 42 nickel material with a thickness of 250 μm as a base material, and a photo-sensitive resin that mainly contains water-soluble polyamide is patterned on the base material using the photolithography method, thereby being formed in a stripe shape having a width of 90 μm and a pitch of 450 μm.

### Manufacturing of Substrate to be Printed

As the substrate 107 to be printed, an active matrix substrate which includes a thin-film transistor that functions as a switching element provided on a support body, a planarizing layer formed with the information, and the pixel electrode 502 which is electrically connected to the thin-film transistor through a contact hole in the planarizing layer was used. The pixel size is 130 μm×450 μm.

The partition wall 503 is formed by coating the end portion of the pixel electrode provided on the active matrix substrate in such a shape that partitions pixels. In order to form the partition wall, a positive resist ZWD6216-6 produced by Zeon corporation was applied on the entire surface of the active matrix substrate by a spin coater to have a drying thickness of 1 μm, and thereafter, the partition wall having a line width of 20 μm was formed on the four sides of each pixel part through photography.

As the hole transport layer on the pixel electrode, an aqueous solution having 1.5 wt % of poly(3,4)-ethylenedioxythiophene/polystyrenesulfonate (PEDOT/PSS) was formed as a film with a film thickness of 100 nm by the spin coating method. Moreover, the formed PEDOT/PSS thin film was decompressed and dried at 100° C. for 1 hour, thereby manufacturing the substrate 107 to be printed.

### Manufacturing of Ink for Formation of Organic Light-Emitting Layer

The following organic light-emitting inks with three colors of red, green, and blue (R, G, and B) were dissolved in xylene so as to be adjusted. The red light-emitting ink (R) is a toluene solution (a red light-emitting material produced by Sumitomo Chemical Co., Ltd., trade name Red1100) of a polyfluorene-based derivative. The green light-emitting ink (G) is a toluene solution (a green light-emitting material produced by Sumitomo Chemical Co., Ltd., trade name Green1300) of a polyfluorene-based derivative. The blue light-emitting ink (B) is a toluene solution (a blue light-emitting material produced by Sumitomo Chemical Co., Ltd., trade name Blue1100) of a polyfluorene-based derivative. The viscosity (first viscosity) of each of the ink solutions is 1.5 mPa·s.

### Printing Process

The organic light-emitting ink having the first viscosity was supplied to the ink tank 109 of the relief printing apparatus and was coated on the 600 line/inch honeycomb anilox roller 101 by the coating device 102. A part of the ink solvent was volatilized by rotating the anilox roller while the plate cylinder and the anilox roller were in asynchronous state. After the rotation for a predetermined time, the viscosity (second viscosity) of the ink was 33 mPa·s, and the anilox roller and the relief plate were caused to abut on each other and the two were caused to be in synchronization with each other, thereby transferring the ink from the anilox roller onto the protruding portion of the relief plate. Moreover, the ink pattern was transferred while the relief plate was caused to come into pressure contact with the substrate 107 to be printed, thereby forming the stripe pattern of the organic light-emitting layer 505 on the substrate 107 to be printed. Thereafter, the anilox roller was further rotated to align the region of the anilox roller coated with the ink with the anilox roller cleaning unit 112, thereby performing cleaning of the anilox roller. The ink and the cleaning liquid were recovered by the recovery tank 111 by the ink recovery unit 110. Printing of the light-emitting layer pattern was further performed on other substrates to be printed several or more times. Last, anilox roller cleaning was performed by the anilox roller cleaning unit 112 and plate cleaning was performed by the plate cleaning unit 125.

By repeating these processes for each of the red organic light-emitting layer, the green organic light-emitting layer, and the blue organic light-emitting layer, the organic light-emitting pattern was obtained. After performing printing for each of the colors, drying was performed in an oven at 130° C. for 1 hour.

After the drying, calcium was formed as a 10 nm film on the organic light-emitting layer formed by the printing, and 300 nm of silver was vacuum-deposited thereon. Last, by using the glass cap 507 and performing sealing, the organic electroluminescent element was manufactured.

### Examples 2 to 4

Subsequently, as Examples 2 to 4, organic electroluminescent elements were manufactured in the same manner as that of Example 1 except that the first viscosity of the organic light-emitting ink was changed in a range of higher than or equal to 1 mPa·s and less than or equal to 15 mPa·s and the second viscosity thereof was changed in a range of higher than or equal to 30 mPa·s and less than or equal to 100 mPa·s.

### Comparative Examples 1 to 4

Subsequently, as Comparative Examples 1 to 4, organic electroluminescent elements were manufactured in the same manner as that of Example 1 except that the first viscosity of the organic light-emitting ink was less than 1 mPa·s or higher than 15 mPa·s and the second viscosity thereof was less than 30 mPa·s or higher than 100 mPa·s.

A table that arranges Examples 1 to 4 and Comparative Examples 1 to 4 is shown as follows.

TABLE 1

| | First | Second | Organic |
|---|---|---|---|
| | viscosity | viscosity | light-emitting |
| | [mPa · s] | [mPa · s] | layer state |
| Example 1 | 1.5 | 33 | Good |
| Example 2 | 5 | 47 | Good |
| Example 3 | 10 | 60 | Good |
| Example 4 | 14 | 95 | Good |
| Comparative | 0.8 | 35 | Film thickness |
| Example 1 | | | unevenness |
| Comparative | 20 | 93 | Film thickness |
| Example 2 | | | unevenness |
| Comparative | 1 | 25 | Transfer defect |
| Example 3 | | | |
| Comparative | 14 | 105 | Transfer defect |
| Example 4 | | | |

From the above table, as the first viscosity of the organic light-emitting ink is changed in a range of higher than or equal to 1 mPa·s and less than or equal to 15 mPa·s and the second viscosity thereof is changed in a range of higher than or equal to 30 mPa·s and less than or equal to 100 mPa·s, the organic light-emitting layer may be properly formed by printing.

On the other hand, in Comparative Example 1, since the first viscosity is too low, the ink moves on the anilox roller and thus the ink film thickness becomes non-uniform, and the organic light-emitting layer after the printing process has an uneven film thickness.

In Comparative Example 2, since the first viscosity is too high, the ink is not uniformly leveled on the anilox roller, and the organic light-emitting layer after the printing process has an uneven film thickness.

In Comparative Example 3, since the second viscosity is too low, the ink flows into the recessed portion of the relief plate and is not transferred from the relief plate, resulting in transfer defect.

In Comparative Example 4, since the second viscosity is too high, the ink remains on the anilox roller during transfer and is not transferred from the relief plate, resulting in transfer defect.

### Comparative Example 5

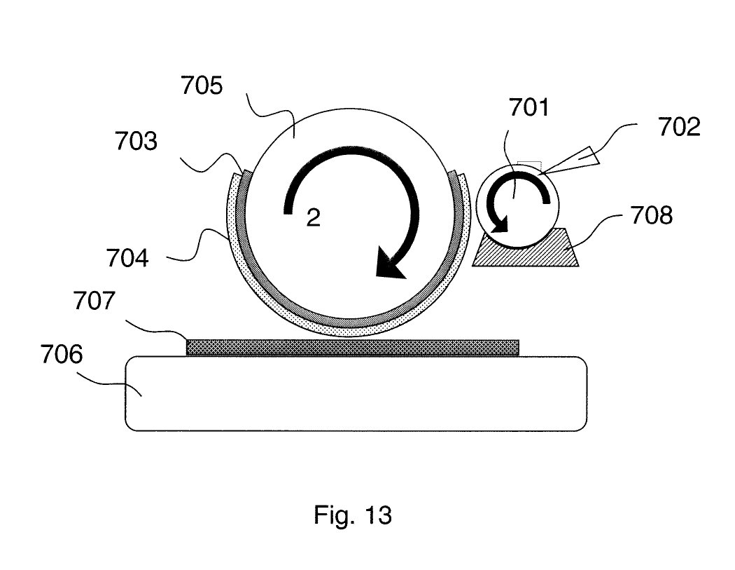

Furthermore, as Comparative Example 5, a relief printing apparatus in which the plate cleaning unit 125 that cleans the relief plate was added to the configuration illustrated in FIG. 13 was used. That is, the relief printing apparatus includes a relief plate 4, a rotary plate cylinder 5 to which the relief plate 4 is mounted with a block copy cushion 3 interposed therebetween, an anilox roller 1 for supplying the ink to the plate surface of the relief plate 4, an ink chamber 8 which supplies the ink to the anilox roller 1, a doctor blade 2 which scrapes off the excess ink on the anilox roller, and a substrate surface plate 6 on which a substrate 7 to be printed is placed.

The relief plate 104 and the substrate to be printed were manufactured in the same order as that of Example 1. The following organic light-emitting inks with three colors of red, green, and blue (R, G, and B) were dissolved in xylene so as to be adjusted. The red light-emitting ink (R) is a toluene solution (a red light-emitting material produced by Sumitomo Chemical Co., Ltd., trade name Red1100) of a polyfluorene-based derivative. The green light-emitting ink (G) is a toluene solution (a green light-emitting material produced by Sumitomo Chemical Co., Ltd., trade name Green1300) of a polyfluorene-based derivative. The blue light-emitting ink (B) is a toluene solution (a blue light-emitting material produced by Sumitomo Chemical Co., Ltd., trade name Blue1100) of a polyfluorene-based derivative. The viscosity of each of the ink solutions is 60 mPa·s.

The organic light-emitting ink was supplied to the ink tank of a relief printing machine, was coated on the 600 line/inch honeycomb anilox roller 701 in the ink chamber 708, and was taken by the doctor blade 702, and thereafter the protruding portion of the relief plate 704 was inked. Moreover, the inked relief plate 104 was caused to come into pressure contact with the substrate 107 to be printed so as to be transferred, thereby forming a stripe pattern on the substrate 107 to be printed. As in the above examples, after the printing machine was cleaned, these processes were repeated for each of the red organic light-emitting layer, the green organic light-emitting layer, and the blue organic light-emitting layer, thereby obtaining the organic light-emitting layer pattern. After performing printing for each of the colors, drying was performed in an oven at 130° C. for 1 hour.

After the drying, calcium was formed as a 10 nm film on the organic light-emitting layer formed by the printing, and 300 nm of silver was vacuum-deposited thereon. Last, by using a glass cap and performing sealing, the organic electroluminescent element was manufactured.

### Element Evaluation

Current was applied to each of the manufactured organic electroluminescent elements to emit light. In Example 1, all substrates uniformly emitted light. However, in Comparative Examples, dark spots had occurred in a plurality of substrates. Moreover, after forming the organic light-emitting layers, in a state before sealing, the amount of foreign matter incorporated into the light-emitting layer was inspected. The inspection was performed using an inspection apparatus capable of detecting foreign matter sizes down to 2 μm using a CCD camera. During the inspection, scanning was performed at 12 pixels×9 pixels for one frame so as to calculate the amount of foreign matter in Example 1 and Comparative Examples.

In Example 1, the maximum amount of foreign matter was 6345 pieces and the average amount thereof was 663 pieces. However, in Comparative Example, 84706 pieces at the maximum, and 22409 pieces on average of foreign matter were incorporated. From this, it was found that according to the relief printing apparatus of the invention, it is possible to form a high-precision pattern and stably reduce the amount of foreign matter without using a doctor blade.

What is claimed is:

1. A relief printing apparatus comprising:
a rotary plate cylinder;
a relief plate disposed on the plate cylinder;
an anilox roller including a surface subjected to unevenness processing, the surface supplying an ink to the relief plate; and
a coating device which forms an ink coating film by applying the ink to the surface of the anilox roller.

2. The relief printing apparatus according to claim 1, further comprising a drying controlling means for controlling a dried state of the ink by accelerating volatilization of a solvent contained in the ink coating film on the anilox roller.

3. The relief printing apparatus according to claim 1, further comprising a controlling means,
wherein the controlling means controls at least an ink coating amount applied by the coating device and a dried state of the ink.

4. The relief printing apparatus according to claim 2, further comprising a moving mechanism for separating the relief plate from the anilox roller,
wherein the drying controlling means is a drying mechanism which is operated in a state where the relief plate and the anilox roller are separated from each other.

5. The relief printing apparatus according to claim 2, wherein the drying controlling means is a mechanism which accelerates volatilization by generating an air current toward a region of the ink coating film.

6. The relief printing apparatus according to claim 2, wherein the drying controlling means is a mechanism which accelerates volatilization by causing a region of the ink coating film to have a low pressure.

7. The relief printing apparatus according to claim 2, wherein the drying controlling means heats the ink coating film using a far-infrared irradiation device.

8. The relief printing apparatus according to claim 1, further comprising an anilox roller cleaning mechanism which cleans the anilox roller.

9. The relief printing apparatus according to claim 8, wherein the anilox roller cleaning mechanism includes:
a cleaning liquid supplying means for discharging a cleaning liquid toward the anilox roller;
a cleaning liquid removing means for removing the cleaning liquid; and
an ink recovery unit which recovers the ink dissolved in the cleaning liquid and the cleaning liquid.

10. The relief printing apparatus according to claim 1, further comprising a plate cleaning mechanism which cleans the relief plate.

11. A method of manufacturing a printed matter manufactured using the relief printing apparatus according to claim 1.

12. A method of manufacturing a printed matter, which supplies an ink onto a relief plate from an anilox roller of which a surface is subjected to unevenness processing, and transfers the ink onto a substrate to be printed from the relief plate, the method comprising:
filling a recessed portion of the surface of the anilox roller with the ink and applying the ink to cover a protruding portion of the surface;
volatilizing the ink to increase a concentration of the ink on the anilox roller;
transferring the ink onto the relief plate from the anilox roller; and
transferring the ink onto the substrate to be printed from the relief plate.

13. The method of manufacturing a printed matter according to claim 12,
wherein a viscosity of the ink in applying the ink to the surface of the anilox roller is greater than or equal to 1 mPa·s and less than or equal to 15 mPa·s, and
a viscosity of the ink in the transferring of the ink onto the substrate to be printed is greater than or equal to 30 mPa·s and less than or equal to 100 mPa·s.

14. A method of manufacturing an organic electroluminescent element which includes, on a substrate, a cathode, an anode, and an organic light-emitting medium layer interposed between the cathode and the anode, the method comprising:
forming the organic light-emitting layer by using the method of manufacturing a printed matter according to claim 12, wherein the ink is an organic light-emitting ink in which an organic light-emitting material is dissolved.
